(19) United States
(12) Patent Application Publication
(10) Pub. No.: US 2014/0150730 A1
(43) Pub. Date: Jun. 5, 2014

(54) LAUNCHER SYSTEM

(71) Applicants: BRYANT Y. KIM, DALLAS, TX (US); JOON S. KIM, DALLAS, TX (US)

(72) Inventors: BRYANT Y. KIM, DALLAS, TX (US); JOON S. KIM, DALLAS, TX (US)

(73) Assignee: DT SYSTEMS, INC., DALLAS, TX (US)

(21) Appl. No.: 14/089,694

(22) Filed: Nov. 25, 2013

Related U.S. Application Data
(60) Provisional application No. 61/730,499, filed on Nov. 27, 2012.

(51) Int. Cl. A01K 15/02; F41B 7/00

(52) U.S. Cl. CPC A01K 15/021; F41B 7/00
USPC 119/720; 124/16

(57) ABSTRACT

A training system is disclosed that includes a controller, a dummy launcher and, optionally, a bird launcher and a pet training collar. In at least one embodiment of the invention, the controller is operable to control any one of the bird launcher, the dummy launcher or the pet training collar. The system thus includes any combination of the controller, the dummy launcher, the pet training collar and the bird launcher. The dummy launcher system includes a base is that is configured to receive a portable dummy launcher that may also be removed from the base for manual operation. The system thus allows a user to select and activate a launcher and then to select the dog training collar to transmit control commands to the dog under training.

### CROSS-REFERENCE TO RELATED APPLICATIONS

The present U.S. Utility Patent Application claims priority U.S. Provisional Application for Patent having a Ser. No. 61/730,499 filed on Nov. 27, 2012.

### BACKGROUND OF THE INVENTION

1. Field of the Invention

The present invention relates to a launcher system for training pets, especially hunting dogs.

2. Description of the Related Art

In general, dummy launchers and bird launchers are known. Typically, each is fired manually to activate a launch mechanism. Dog training systems include controllers that wirelessly generate control commands to stimulate the pet under training The dummy launchers, bird launchers and dog training systems are separate and distinct.

FIG. 1 illustrates the construction of a conventional prior art dummy launcher. As shown, the conventional dummy launcher includes a firing assembly 100. In the structure of the firing assembly 100, a body 104 is tapered from a larger upper portion thereof to a smaller lower portion thereof, the body 104 having a fixed piece 108 on the top end thereof, a housing inside of the body 104. The dummy launcher comprises a barrel 124 adapted to be coupled with a coupling hole of the fixed member of the fixed assembly and having a guide projection extended there from. A firing pin (not shown) is mounted into the housing in such a manner as to protrude through a mounting hole. A grip 112 is formed about a sliding axis (not shown) that is spring loaded. When grip 112 is grabbed and slid axially away from the dummy launcher, the internal spring is stretched creating strong pulling force back towards the body of the dummy launcher.

The structure of the fixed assembly 116 includes a fixed member 120, a barrel 124, and a locking arm 128. Fixed member 120 is formed with a coupling hole threaded internally to receive a threaded portion of barrel 124. Barrel 124 has a passageway passed through the interior thereof, and a rubber ring 132 formed at the outer end of barrel 124. A housing groove 136 is formed around the interior of fixed member 120 to couple with firing assembly 100. Locking arm 128 is moveably attached to fixed member 120 by a second fixed pin 140 inserted into second fixed aperture 144.

In operation, when the grip 112 is slid axially away from the barrel 124 of the dummy launcher and of firing assembly 100 and then is released, a firing pin strikes a firearm blank cause the blank to fire and launch the dummy from barrel 124 of the dummy launcher firing assembly 100.

### SUMMARY OF THE INVENTION

The present invention is for a system that includes a controller and one or more of a dummy launcher, a bird launcher and a training collar. The controller is configured to communicate with any one of the dummy launcher, the bird launcher and the training collar. As such, a system that includes one or more of these types of devices that are controlled by the single controller. In one embodiment, the dummy launcher includes a base that is configured to receive and hold a hand-held type of dummy launcher that may be operated manually. The base includes, in one embodiment, a ratchet system that engages the hand-held type of dummy launcher to cock the launcher and to release the spring activated firing mechanism when a control signal is received from the controller.

### BRIEF DESCRIPTION OF THE DRAWINGS

The above and other objects, features, and advantages of the present invention will be apparent from the following detailed description of the preferred embodiments of the invention in conjunction with the accompanying drawings, in which:

FIG. 1 illustrates the construction of a conventional prior art dummy launcher.

FIG. 2 is a side view of one embodiment of the invention.

FIG. 3 is a side view of the embodiment of FIG. 2 in which the launcher body of the launcher base has been angularly adjusted for a firing position.

FIG. 4 is a functional block diagram of one embodiment of a launcher and training system.

FIG. 5 is a perspective view of a block assembly according to one embodiment of the invention for attaching to a grip of a dummy launcher.

FIG. 6 shows the block assembly of FIG. 5 as attached to the grip of a dummy launcher.

FIG. 7 shows a dummy launcher base and, more particularly, the launcher body 212, the remote receiver 232, and a ratchet 228.

FIG. 8 shows an embodiment of a mechanism for firing or actuating a launcher.

FIGS. 9 and 10 are cutaway views of a portion of the dummy launcher according to one embodiment of the invention.

FIG. 11 is a flowchart illustrating a method for training an animal, according one embodiment of the invention.

### DETAILED DESCRIPTION OF THE EXEMPLARY EMBODIMENTS

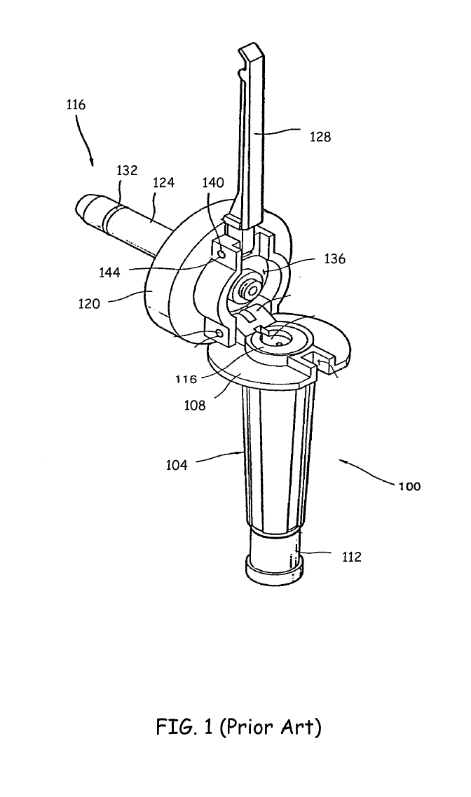

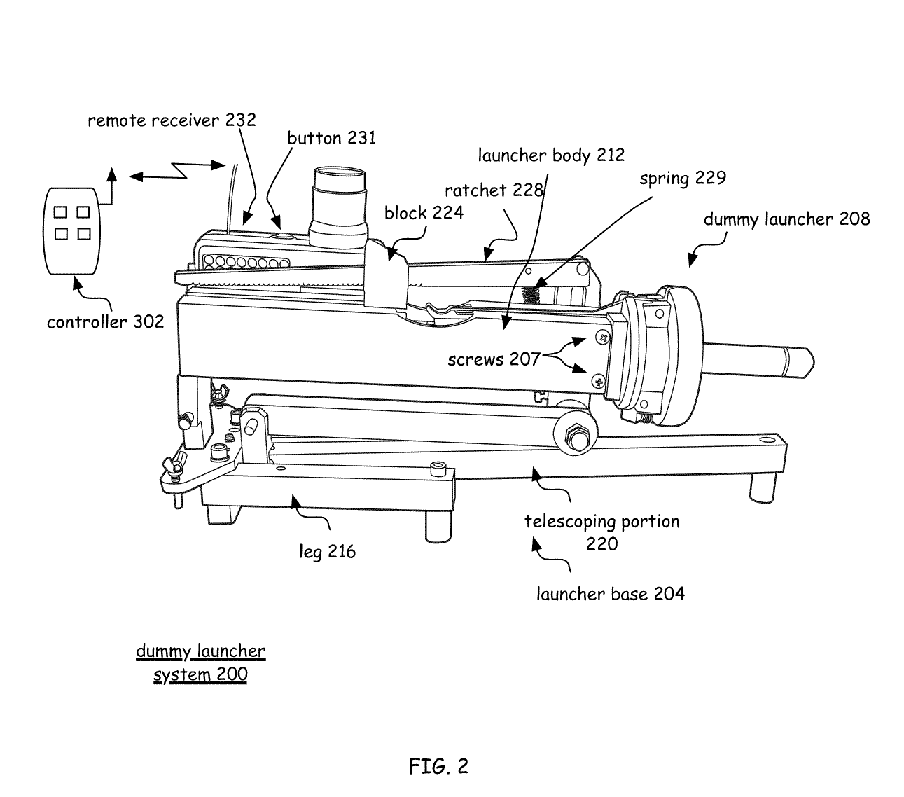

FIG. 2 is a side view of one embodiment of the invention. As may be seen, a dummy launcher system 200 includes a launcher base 204 and an associated dummy launcher 208. The launcher base 204 is configured to receive the dummy launcher 208. In the described embodiment, the dummy launcher 208 is a prior art dummy launcher such as that shown in FIG. 1. More specifically, a launcher body 212 of launcher base 204 is configured to receive and securely hold the dummy launcher 208. In the illustrated embodiment, the dummy launcher 208 is securely held by two screws 207 (per side). Two of the four screws 207 are shown adjacent to the dummy launcher 208. The launcher base 204 includes two legs 216 that swivel or turn in an outward direction to add stability to the launcher base 204. Additionally, a telescoping portion 220 allows the launcher body to set to a desired launch angle.

A block 224 that is a part of a cocking mechanism that secures to a grip of the dummy launcher (shown in FIG. 1) is shown. The block slides axially along the launcher body within some guide rails now shown here in FIG. 2. The block has an outwardly extending portion (or catch) that engages with teeth of the ratchet 228. A spring 229 is connected to ratchet 228 and launcher body 212 to create a downward force to hold ratchet 228 firmly against the catch (now shown here) of block 224. A remote receiver 232 is configured to release the ratchet upon receipt of a specified control signal transmitted by a wireless controller 302. Alternatively, remote receiver 232 includes a button 231 to allow selection of As will be shown below, an actuator urges the ratchet upward to release the block 224 to allow the dummy launcher to fire.

The described embodiment includes a dummy launcher configured to launch a dummy wherein the dummy launcher includes a spring activated launching mechanism configured to launch a dummy when activated. A launcher base is configured to receive and securely hold the dummy launcher and includes a launcher body, a ratchet system that engages a cocking mechanism configured to attach to the spring activated launching mechanism of the dummy launcher and a remote receiver configured to release the ratchet from the cocking mechanism upon receiving an associated control command from a remote transmitter.

More specifically, the remote controlled launcher system includes a housing defining a passageway wherein a lower portion of the dummy launcher (i.e., the firing assembly 100) may be inserted into the passageway. Thus, the dummy launcher may be securely installed into the launcher body 212 (using the screws 207). The dummy launcher of the remote controlled launcher system further includes a firing mechanism that is configured to strike a blank with a firing pin to fire the blank when the spring activated launching mechanism is activated in one embodiment. The dummy launcher, after being installed, is therefore configured to be opened to insert a firearm blank (e.g., a shell with gun powder sized to fit a 22 caliber firearm).

The remote controlled launcher system may also include a ratchet for coupling to a cocking mechanism when the cocking mechanism is coupled to the spring activated firing assembly 100 to allow the cocking mechanism to be pulled into a firing position and to be held by the ratchet and a ratchet release mechanism configured to release the ratchet the from the cocking mechanism.

A dummy is then mounted onto a barrel of the dummy launcher. A firing angle of the dummy launcher is set by adjusting the telescoping portion 220 of launcher base 204.

The aforementioned passageway further defines a pair of opposing rails for securely holding the block and wherein the block is configured to couple to the spring activated firing mechanism, slide between the opposing rails, engage the ratchet when the ratchet is operably disposed in a first position, and disengage from the ratchet when the ratchet is disposed in a second position to allow the block (and attached grip of the dummy launcher) to slide forward to cause a firing pin to fire the blank and launch the dummy.

Thus, once the system is set up as described, block 224 is slid axially along launcher body 212 to pull the attached spring loaded dummy launcher grip away from the firing end (opposite end) of dummy launcher 208. Ratchet 228 engages the catch of block 224 to securely hold the grip of dummy launcher 208. Upon depression of a specified control button for controller 302, a command is transmitted to the receiver 232 to prompt the receiver 232 to upwardly rotate an actuator that releases ratchet 228 to allow dummy launcher 208 to fire to launch the dummy.

The remote controlled launcher system may include a block that defines at least one concave aperture for receiving a user's finger or thumb to help the user hold the block while the block is slid between the opposing rails to cock the cocking mechanism.

The remote controlled launcher system may include a plurality of launcher bases wherein the controller 302 is configured to selectively communicate with a plurality of remote receivers each coupled to the plurality of launcher bases to allow a user to select which of the pair (or plurality) of dummy launchers fires for the purpose of training a hunting dog.

Thus, the remote controlled launcher system may include a controller that is configured to communicate with and send control signals to the remote receiver and at least one of a second remote receiver, a dog training collar receiver and a remote receiver for a bird launcher.

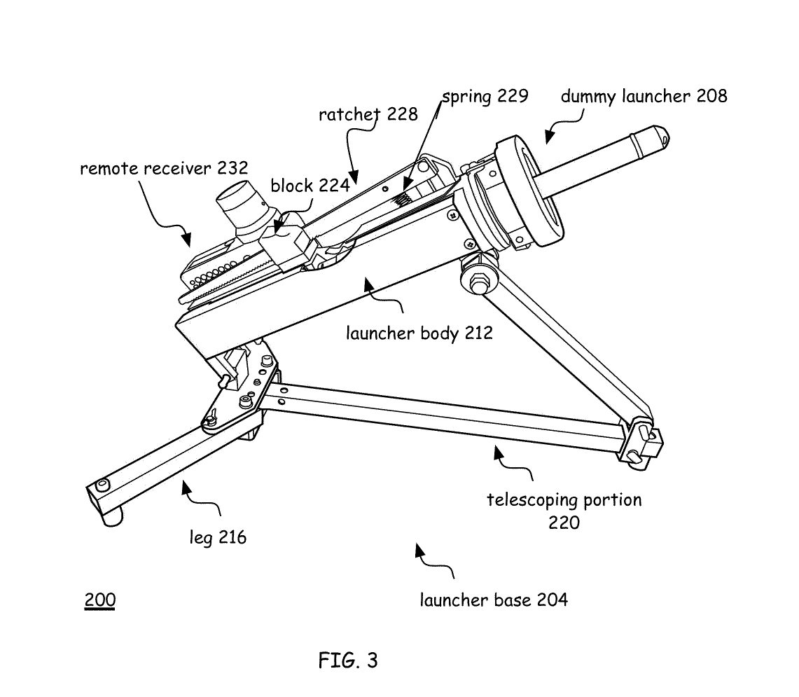

FIG. 3 is a side view of the embodiment of FIG. 2 in which the launcher body of the launcher base has been angularly adjusted for a firing position. As may be seen, the telescoping portion 220 has been adjusted to place the launcher body 212 into the firing angle relative to horizontal as shown. As may be seen, however, the block has not been slid along the launcher body to activate the spring mechanism of the dummy launcher and to place the system in a firing position.

In one embodiment, the remote controlled launcher system includes a launcher base that comprises at least two legs 216 that may be rotated between a storage position and an outwardly extending position to provide stability for the launcher base. The launcher base also includes a telescoping portion 220 to allow a trajectory angle to be set by a user.

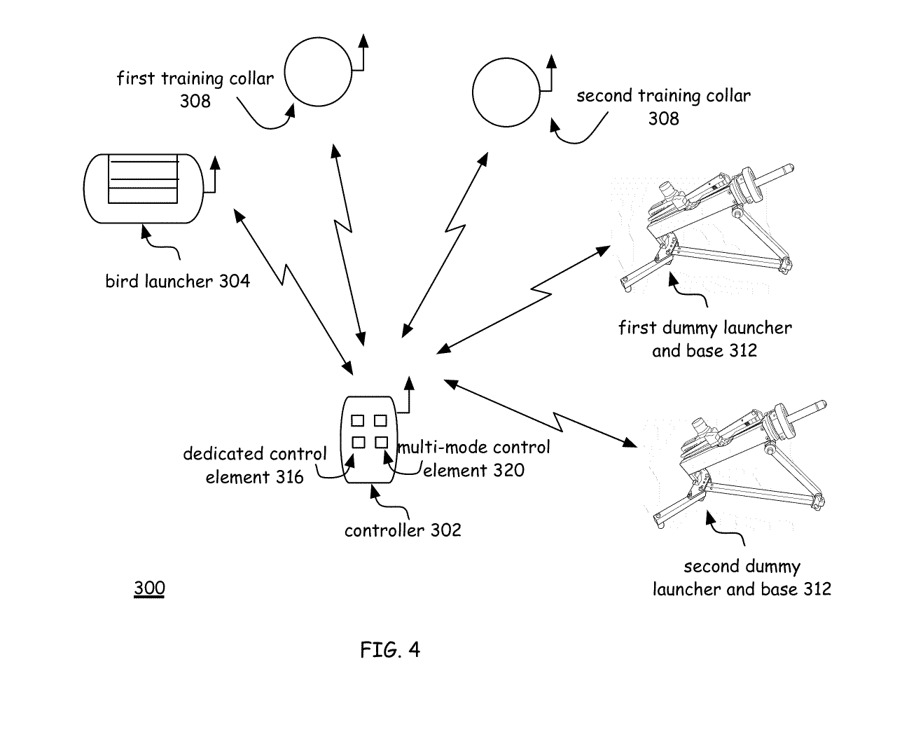

FIG. 4 is a functional block diagram of one embodiment of a launcher and training system. A system 300 includes controller 302 that is configured and operable to communicate with a receiver for a bird launcher 304, a training collar 308, and a first and second dummy launcher and base 312. Each of the devices 304-312 includes a receiver that communicates with controller 302. These various receivers have, in one embodiment, differing communication signals and/or protocols for communication with controller 302.

Controller 302 includes logic to allow a user to select which of the receiver devices 304-312 that controller 302 will communicate with. Based on the selected receiver, controller 302 will send associated communication and/or control signals. Further, while controller 302 may have control elements that are associated with a certain type of receiver (e.g., a launcher or the training collar), controller 302 may also have control elements that are multi-mode control elements. For example, a given control element may, when depressed, prompt controller 302 to transmit a nick command or a shock command whenever a training collar 308 is selected and, further, to prompt controller 302 to transmit a launch command when either a bird launcher 304 or a dummy launcher 312 is selected. As may further be seen, controller 302 includes a plurality of control elements. These control elements include, in the described embodiment, at least one dedicated control element 316 and at least one multi-mode control element 320. The logic of operation of these control elements may be defined by any combination of internal software or hardware.

One aspect of the embodiment of FIG. 4 is that a user may select one of the launchers 304 or 312, perform an associated launch, and then select either the first or second training collar 308 to transmit control commands to the animal (dog) being trained. As such, the system includes one controller that may, conveniently, be used to control the different systems while training a dog. It should be understood the invention is not limited to two training collars or two dummy launchers and bases.

The remote controlled launcher system may include, therefore, in one embodiment, a controller, at least two remote receivers with associated dummy launchers and launcher bases, and at least one dog training collar and associated collar receiver. The controller is configured to allow a user to select between the at least two remote dummy launcher receivers and the dog training collar receiver (or two dog training collars if there are two) and, when the user depresses a control element, the controller sends a corresponding control signal to the selected receiver.

There are many embodiment for a controller. In one embodiment, a controller for pet training systems includes wireless communication circuitry configured to communicate with the dummy launcher receivers, and selection logic configured to allow a user to select from a plurality of dummy launchers. The controller further includes logic for prompting the controller to transmit control commands for a selected one of the plurality of dummy launchers. The control commands are transmitted upon selection of a control element (button or switch) and logic for generating and transmitting an associated control command for the selected one of the plurality of dummy launchers upon depression by the user of the control element.

The controller may include selection logic is further configured to allow the user to select a pet training collar receiver to generate control commands to train the pet. The selection logic may allow the user to select from one of a plurality of pet training collar receivers. In one embodiment, the controller further comprises control elements that are dedicated to training functions that are transmitted for the selected pet training collar receiver.

In one embodiment, the controller has at least one control element that has a plurality of associated functions based upon whether the a pet training collar receiver or a dummy launcher or bird launcher receiver is selected by the selection logic. The selection logic may comprise a switch or logic to interpret patterns of switch depressions to select from the plurality of dummy launchers.

In another embodiment, a remote controlled launcher system comprises a controller, at least one remote receiver with an associated dummy launcher and launcher base, at least one remote receiver with an associated bird launcher, and at least one dog training collar and associated collar receiver. The controller is configured to allow a user to select between the at least at least one remote receiver with an associated dummy launcher and launcher base, the at least one remote receiver with an associated bird launcher, and the dog training collar receiver and further wherein, when the user depresses a control element, the controller sends a corresponding control signal to the selected receiver.

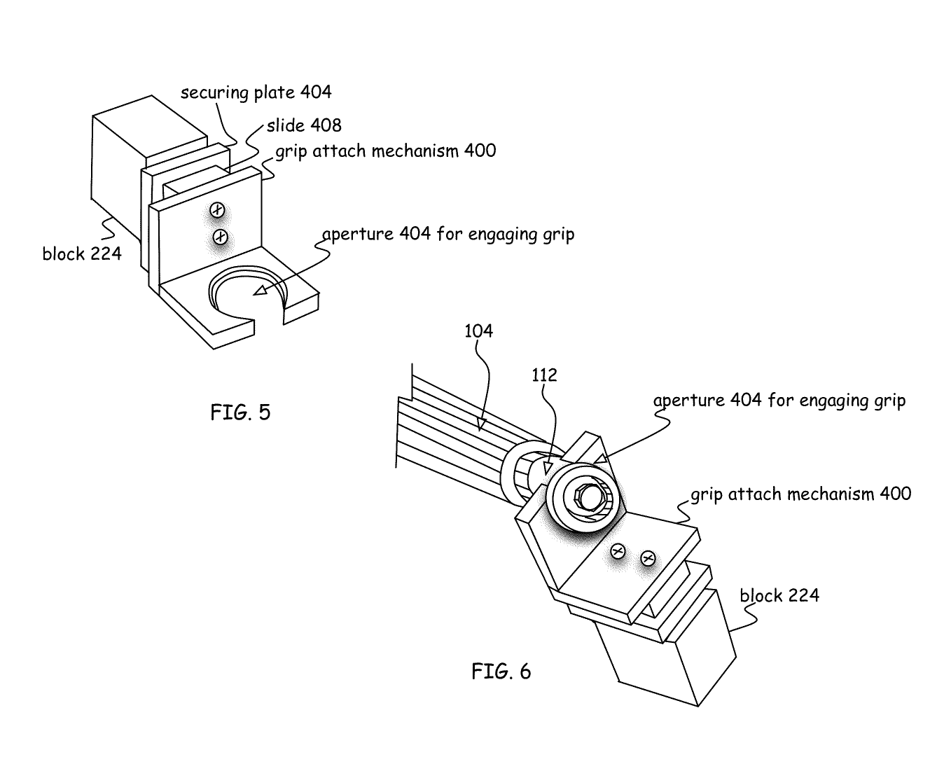

FIG. 5 is a perspective view of a block assembly according to one embodiment of the invention for attaching to a grip of a dummy launcher. As may be seen, block 224 is attached to a grip attach mechanism 400 that defines an aperture 404 for engaging the dummy launcher grip. Accordingly, as block assembly is slid axially along the launcher base body grip attach mechanism pulls the grip away from the dummy launcher to place the dummy launcher into a firing position. As may further be seen, the block assembly of FIG. 5 includes a securing plate 404 and a slide 408. Securing plate 408 rides above a pair of opposed guide rails of the launcher body while the grip attach mechanism rides below the pair of opposed guide rails. The slide 408 rides between the pair of opposed rails in a channel space defined by opposing guide rails.

FIG. 6 shows the block assembly of FIG. 5 as attached to the grip of a dummy launcher.

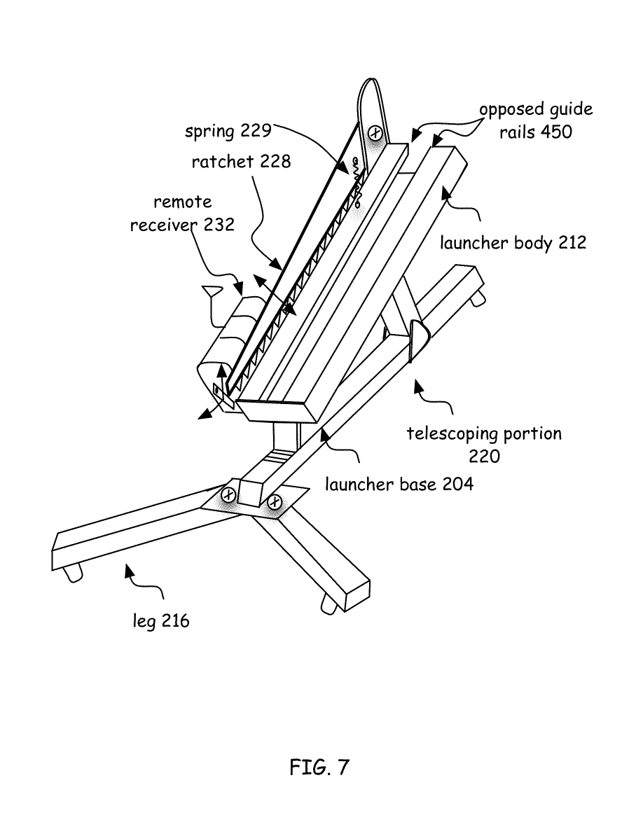

FIG. 7 shows a dummy launcher base and, more particularly, the launcher body 212, the remote receiver 232, and a ratchet 228. As may be seen, launcher body 212, which is disposed in an angular firing position though no dummy launcher is installed, defines a pair of opposed guide rails 450. These guide rails 450 are, as described previously, for guiding the block along the launcher body 212. More specifically, referring back to FIG. 5, grip attach mechanism 400 slides within the launcher body 212 while a securing plate 404 and block 224 slide outside of launcher body 212. Disposed between securing plate 404 and grip attach mechanism 400 is slide 408 that slides between the pair of opposing guide rails 450.

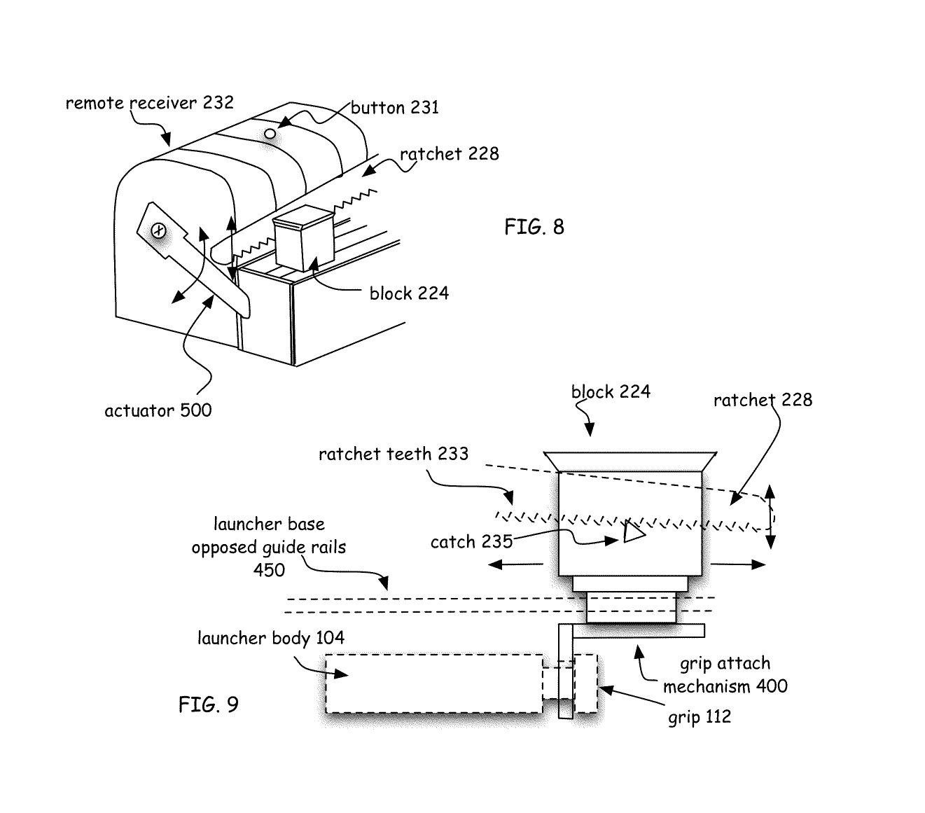

FIG. 8 shows an embodiment of a mechanism for firing or actuating a launcher. As may be seen, the remote receiver 232 includes an actuator 500 that rotates to disengage a ratchet 228 from a catch that extends outwardly from block 224 that has been slid into a firing position. When the remote receiver 232 receives a launch signal, it rotates the actuator 500 in an upward direction to disengage ratchet 228 to allow the spring within the dummy launcher to snap to a resting position to cause the firing pin to fire the blank and launch the dummy.

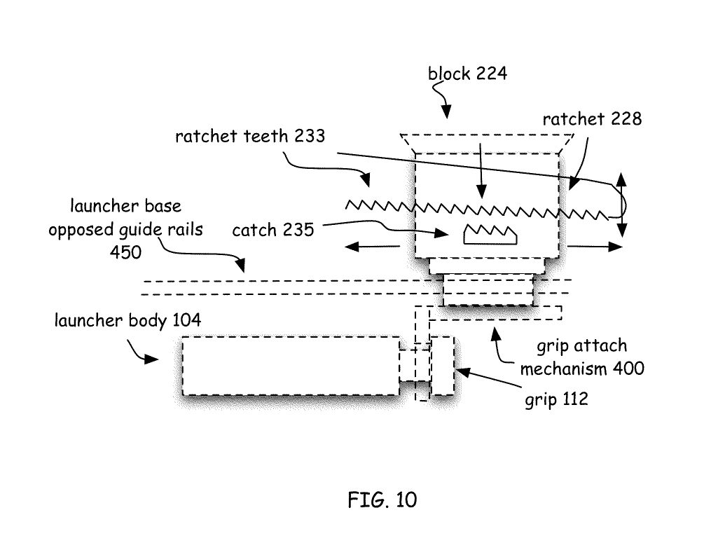

FIGS. 9 and 10 are cutaway views of a portion of the dummy launcher according to one embodiment of the invention. Referring to FIG. 9, a ratchet 228 forms a series of teeth 233 that engage an outwardly extending portion or catch 235 of block 224. As may be seen, catch 235 comprises a single element that engages teeth 233. A spring 229 (not shown in this figure) is used to create a downward force to cause the ratchet 228 to engage with the block 224 and to stay engaged. Thus, actuator 500 is required to apply sufficient force to overcome gravity and the force of the spring to disengage the ratchet from the engaged position. Thereafter, the spring mechanism of the firing assembly 100 of the dummy launcher causes the dummy launcher to slam a firing pin into a loaded blank to fire the dummy launcher in one embodiment of the invention.

Referring now to FIG. 10, a alternative embodiment of the catch is shown. Here, catch 235 includes a plurality of teeth that are configured to match and engage the teeth 233 of ratchet 228.

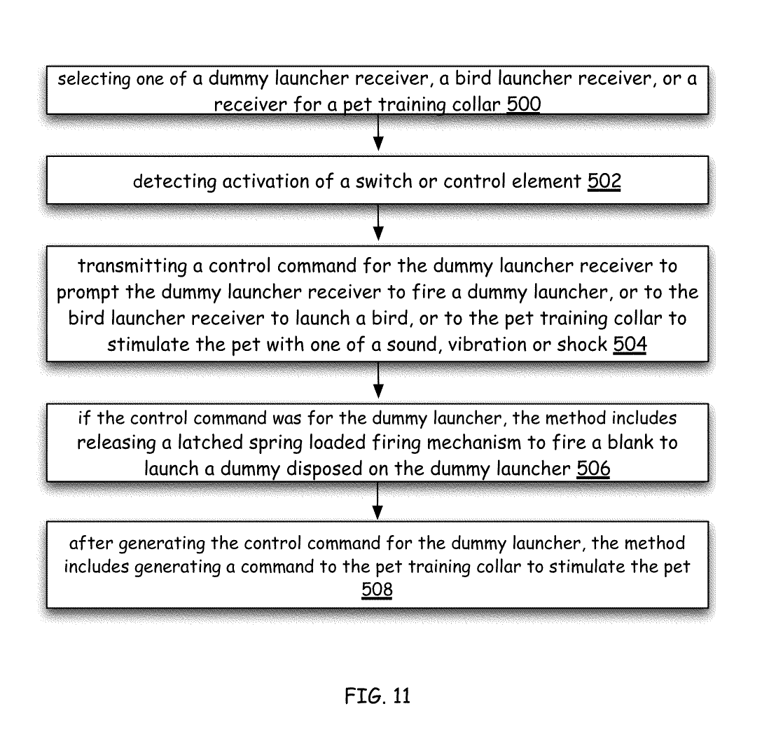

FIG. 11 is a flowchart illustrating a method for training an animal, according one embodiment of the invention. The method commences with selecting, using selection logic (e.g., in a controller or control element), one of a dummy launcher receiver, a bird launcher receiver, or a receiver for a pet training collar for receiving a control command from the controller (500). In the described embodiment of the inventive system, the controller is configured to communicate at with at least two types of devices. For example, the controller may be configured to communicate with the pet training collar and the dummy launcher. In an alternative embodiment, the controller is configured to communicate with the bird launcher as well as the dummy launcher. In a third embodiment, the controller is configured to communicate with all three.

Thereafter, the method includes detecting activation of a switch or control element (502). The switch or control element may be one that is dedicated to the particular receiver (e.g., a receiver for the dummy launcher, the pet training collar or the bird launcher) or one that may be used for any of the three receivers depending upon a selected operational mode. Responsive to step 502, the method includes transmitting a control command for the dummy launcher receiver to prompt the dummy launcher receiver to fire a dummy launcher, or to the bird launcher receiver to launch a bird, or to the pet training collar to stimulate the pet with one of a sound, vibration or shock (504).

The preceding steps are steps performed by a hand held controller that is configured to communicate with one of the dummy launcher receiver, the bird launcher receiver, or the receiver for a pet training collar. With respect to a receiver for a dummy launcher, the method also comprises releasing a latched spring loaded firing mechanism to fire a blank to launch a dummy disposed on the dummy launcher (506). In one embodiment of the inventive method, the method includes, after transmitting the control signal to the dummy launcher (or bird launcher), generating a command to the pet training collar to stimulate the pet 508). This step may be performed after the user selects the pet training collar as the target device or automatically by internal logic within the controller.

While the dummy launcher of the described embodiment is a spring activated launcher that fires a blank, other types of launchers may be used including spring activated launchers and launchers that utilize air pressure to shoot a dummy into the air to train the animal.

The invention disclosed herein is susceptible to various modifications and alternative forms. Specific embodiments therefore have been shown by way of example in the drawings and detailed description. For example, anyone of the embodiments for control elements and their disposition or placement on a transmitter or control unit may be used for anyone of the plurality of controller/transmitter configurations. It should be understood, however, that the drawings and detailed description thereto are not intended to limit the invention to the particular form disclosed, but on the contrary, the invention is to cover all modifications, equivalents, and alternatives falling within the spirit and scope of the present invention as defined by the claims.

What is claimed is:

1. A remote controlled launcher system, comprising:
a dummy launcher configured to launch a dummy, the dummy launcher further including a spring activated launching mechanism configured to launch a dummy when activated;
a launcher base configured to receive and securely hold the dummy launcher; the launcher base further including:
a launcher body;
a cocking mechanism configured to attach to the spring activated launching mechanism;
a receiver configured to release the cocking mechanism upon receiving an associated control command from a remote transmitter; and
a wireless controller configured to send control commands to the receiver to prompt the receiver to release the cocking mechanism.

2. The remote controlled launcher system of claim 1 further including a firing mechanism that is configured to strike a blank with a firing pin to fire the blank when the spring activated launching mechanism is activated.

3. The remote controlled launcher system of claim 2 further including a ratchet for coupling to the cocking mechanism when the cocking mechanism is coupled to the spring activated firing mechanism to allow the cocking mechanism to be pulled into a firing position and to be held by the ratchet; and
a ratchet release mechanism configured to release the ratchet the from the cocking mechanism.

4. The remote controlled launcher system of claim 3, comprising:
a housing defining a passageway wherein a lower portion of the dummy launcher may be inserted into the passageway;
the passageway further defining a pair of opposing rails for securely holding a block; and
wherein the block is configured to:
couple to the spring activated firing mechanism;
slide between the opposing rails;
engage the ratchet when the ratchet is operably disposed in a first position; and
disengage from the ratchet when the ratchet is disposed in a second position.

5. The remote controlled launcher system of claim 4 wherein the block defines at least one concave aperture for receiving a user's finger or thumb to help the user hold the block while the block is slid between the opposing rails to cock the cocking mechanism.

6. The remote controlled launcher system of claim 1 further comprising a controller.

7. The remote controlled launcher system of claim 6 wherein:
the remote controlled launcher system comprises a plurality of launcher bases; and
the controller is configured to selectively communicate with a plurality of remote receivers each coupled to the plurality of launcher bases.

8. The remote controlled launcher system of claim 6 wherein the controller is configured to communicate with and send control signals to the remote receiver and at least one of:
a second remote receiver;
a dog training collar receiver; and
a remote receiver for a bird launcher.

9. The remote controlled launcher system of claim 8 wherein the control signals that are transmitted by the controller are based on the type of device that is selected for control.

10. The remote controlled launcher system of claim 1 wherein the dummy launcher comprises a firing mechanism that is configured to be fired manually when not inserted into the launcher base.

11. The remote controlled launcher system of claim 1 wherein the system comprises:
a controller;
at least two remote receivers with associated dummy launchers and launcher bases;
at least one dog training collar and associated collar receiver; and
wherein the controller is configured to allow a user to select between the at least two remote dummy launcher receivers and the dog training collar receiver and further wherein, when the user depresses a control element, the controller sends a corresponding control signal to the selected receiver.

12. The remote controlled launcher system of claim 1 wherein the launcher base comprises at least two legs that may be rotated between a storage position and an outwardly extending position to provide stability for the launcher base.

13. The remote controlled launcher system of claim 1 wherein the launcher base includes a telescoping portion to allow a trajectory angle to be set by a user.

14. A controller for pet training systems, comprising:
wireless communication circuitry configured to communicate with dummy launcher receivers;
selection logic configured to allow a user to select from a plurality of dummy launchers;
logic for prompting the controller to transmit control commands for a selected one of the plurality of dummy launchers;
a control element; and
logic for generating and transmitting an associated control command for the selected one of the plurality of dummy launchers upon depression by the user of the control element.

15. The controller of claim 14 wherein the selection logic is further configured to allow the user to select a pet training collar receiver to generate control commands to train the pet.

16. The controller of claim 15 wherein the selection logic allows the user to select from one of a plurality of pet training collar receivers.

17. The controller of claim 15 wherein the controller further comprises control elements that are dedicated to training functions that are transmitted for the selected pet training collar receiver.

18. The controller of claim 15 wherein at least one control element has a plurality of associated functions based upon whether the a pet training collar receiver or a dummy launcher receiver is selected by the selection logic.

19. (canceled)

20. The controller of claim 14 wherein the selection logic comprises circuitry configured to interpret patterns of switch depressions to select from the plurality of dummy launchers.

21-24. (canceled)

25. A remote controlled launcher system of claim, comprises:
a controller;
at least one remote receiver with an associated dummy launcher and launcher base;
at least one remote receiver with an associated bird launcher;
at least one dog training collar and associated collar receiver; and
wherein the controller is configured to allow a user to select between the at least at least one remote receiver with an associated dummy launcher and launcher base, the at least one remote receiver with an associated bird launcher, and the dog training collar receiver and further wherein, when the user depresses a control element, the controller sends a corresponding control signal to the selected receiver.
